(19) United States
(12) Patent Application Publication
(10) Pub. No.: US 2024/0268384 A1
(43) Pub. Date: Aug. 15, 2024

(54) COMPOSITIONS FOR DISSOLVING MEALYBUG WAX

(71) Applicant: Indian Council of Agricultural Research, Bengaluru (IN)

(72) Inventors: Kamala Jayanthi, P.D., Bengaluru (IN); Jayanthi Mala, B.R., Bengaluru (IN); P. Saravan Kumar, Bengaluru (IN)

(73) Assignee: Indian Council of Agricultural Research, Bengaluru (IN)

(21) Appl. No.: 18/569,173

(22) PCT Filed: Feb. 4, 2022
(86) PCT No.: PCT/IB2022/050984

§ 371 Date: Dec. 11, 2023

(30) Foreign Application Priority Data
Jun. 9, 2021 (IN) 202141025695

(51) Int. Cl. A01N 37/44; A01N 31/02; A01P 7/04

(52) U.S. Cl. CPC A01N 37/44; A01N 31/02; A01P 7/04

(57) ABSTRACT

The present disclosure relates generally to the field of control and management of mealybugs. Specifically, the present disclosure provides a composition for dissolving the protective wax coating on mealybug, wherein the composition comprises propane-1,2,3-triol and ethyl-4-aminobenzoate. The disclosure also provides a method of controlling mealybug infestation by applying the composition.

### FIELD OF THE INVENTION

The present disclosure relates generally to the field of control and management of mealybugs. Specifically, the present disclosure provides a composition for dissolving the protective wax coating on mealybugs. More specifically, the present disclosure provides a composition for dissolving mealybug body wax comprising propane-1,2,3-triol and ethyl-4-aminobenzoate.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Mealybugs are sap feeding insects belonging to the Order Hemiptera, family—Pseudococcidae. They are small, oval, plant-sucking polyphagous pests that feed on various plants in agriculture, horticulture, plantations and other commercially cultivated crops including kitchen gardens, greenhouses, home gardens, landscapes, and other indoor settings. They thrive in warm summer climates and some species can also survive in cold weathers. They are soft-bodied piercing-sucking sap feeders usually found in dense white colonies on stems, fruits, leaves and roots that lead to stunted growth, wilting and decay of plants. Thus, these bugs are capable of severe crop damage and must be controlled.

The management protocols for these pests revolve around conventional chemical insecticides, botanical oils or formulations with multiple spray recommendations. However, mealybugs are covered with fuzzy white filaments with a waxy, mealy coating, also called mealybug wax, which provides a protective layer on the insects and makes it difficult to manage them through conventional methods of pest treatment. For instance, the protective mealybug wax does not let insecticides penetrate and reach the bug. Thus, existing methods are only partially effective and multiple applications of insecticides are warranted for its management. Further, repeated spraying of chemical insecticides leads to development of resistance in bugs thereby making chemical control less desirable. As mealybugs are very difficult-to-manage insects, current approaches like cultural practices, monitoring, using biological control agents like predators, parasitoids, chemical insecticides with systemic action or a combination of above are not enough. New innovative methods need to be designed to overcome the problems associated with protection provided by mealybug wax.

Thus, there is a pressing need in the art to find solutions to the problem of mealybug wax and consequently controlling and managing the infestation of mealybugs. The present disclosure fulfils the existing needs, at least in part, and alleviates one or more shortcomings of the conventional procedures.

### OBJECTS OF THE INVENTION

An object of the present disclosure is to provide a composition that can solubilize the mealybug protective wax coating.

An object of the present disclosure is to provide a composition that can solubilize the mealybug protective wax coating, which acts as a barrier for conventional insecticidal penetration.

### SUMMARY OF THE INVENTION

This summary is provided to introduce a selection of concepts in a simplified form that are further described below in Detailed Description section. This summary is not intended to identify key features or essential features of the claimed subject matter, nor is it intended to be used as an aid in determining the scope of the claimed subject matter.

In general aspects, the present disclosure provides a composition for dissolving mealybug wax comprising a simple polyol and an aminobenzoate ester.

In an aspect, the present disclosure provides a composition for dissolving mealybug wax comprising active components propane-1, 2, 3-triol and ethyl-4-aminobenzoate.

In one aspect, propane-1, 2, 3-triol may be present in a concentration range of about 1% to about 10% of the composition. In an embodiment, ethyl-4-aminobenzoate may be present in a concentration range of about 1% to about 10% of the composition.

In one aspect, the composition further comprises a solvent. The solvent may be any suitable polar solvent, capable of dissolving the active components, including organic solvents selected from the group comprising of ethyl alcohol, acetone, methanol, ethyl methyl ketone, propan-1-ol (n-propanol), butan-1-ol (n-butanol), 3-methyl-butan-1-ol (isoamyl alcohol), 2-methylpropan-1-ol (isobutyl alcohol), trichloromethane (chloroform), ethoxyethane (ethyl ether) and combinations thereof.

In one aspect, the present disclosure provides a composition for dissolving mealybug wax comprising propane-1, 2, 3-triol, ethyl-4-aminobenzoate and ethyl alcohol. In an embodiment, ethyl alcohol may be present in a concentration ranging from about 80% to about 98% of the composition.

In an embodiment, propane-1, 2, 3-triol, ethyl-4-aminobenzoate and ethyl alcohol may be present in a ratio range of about 1:1:80 to about 10:10:100.

In an aspect, the present disclosure provides a formulation for solubilizing mealybug wax comprising propane-1, 2, 3-triol, ethyl-4-aminobenzoate, a solvent and an agriculturally acceptable excipient. The agriculturally acceptable excipient may be those well known to a person of skill in the art, including but not limited to, carriers, diluents, emulsifiers, gelling agents, thickening agents, suspension agents, stabilizers, tackifiers, absorption or adsorption enhancing agents, adjuvants or mixtures thereof.

In another aspect, the present disclosure provides a method of controlling mealybug infestation said method comprising the step of applying to the locus of mealybug infestation a composition comprising propane-1, 2, 3-triol and ethyl-4-aminobenzoate.

Other aspects of the invention will be set forth in the description which follows, and in part will be apparent from the description, or may be learnt by the practice of the invention.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIGS. 1A-B are bar graphs showing percentage of wax dissolution of pink mealybugs, Maconellicoccus hirsutus, by Composition C1 as per one of the exemplary embodiments of the present disclosure, comparative compositions C2 and C3 with individual ingredients, and Control (distilled water) with and without sticker after 24 hrs and 48 hrs respectively.

FIGS. 2A-B are bar graphs showing percentage mortality of pink mealybugs, Maconellicoccus hirsutus, due to mealybugs wax degradation by Composition C1 as per one of the exemplary embodiments of the present disclosure, comparative compositions C2 and C3 with individual ingredients, and Control (distilled water) with and without sticker after 24 hrs and 48 hrs respectively.

FIGS. 3A-B are photographic images depicting the laboratory trial with application of the Composition C1 as per one of the exemplary embodiments. FIG. 3A shows pumpkin infested with mature mealybugs (encircled), Planococcus citrii, FIG. 3B shows the same pumpkin after topical application by spraying of the Composition C1 after 24 h showing solubilization of the mealybug wax.

FIGS. 4A-B depict effect of application of Composition C1 as per one of the exemplary embodiments in field trial on Annona mealybug, Planococcus citrii. FIG. 3A is a bar graph showing percentage mortality due to mealywax solubilization by the composition C1. FIG. 3B is comparative photographic images of annona fruit before and after treatment with the composition C1 showing solubilization of the mealybugs wax.

FIGS. 5A-B depict effect of application of Composition C1 as per one of the exemplary embodiments in field trial on mango mealybug, Rastrococcus iceryoides. FIG. 4A is a bar graph showing percentage mortality due to mealy wax solubilization by the composition C1. FIG. 4B is comparative photographic images of mango leaf before and after treatment with the composition C1 showing solubilization of the mealybugs wax.

FIGS. 6A-B are photographic images depicting effect of application of Composition C1 as per one of the exemplary embodiments in field trial on Betel vine mealybugs. FIG. 6A is a photographic image of betel vine twig covered with white mealybug wax before spraying the composition, and FIG. 6B is a photographic image of the same twig with mealybugs wax dissolved after spraying the composition, exposing brownish red mealybugs.

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, numbers have been used for quantifying weights, percentages, ratios, and so forth, to describe and claim certain embodiments of the invention and are to be understood as being modified in some instances by the term “about.” When used, the term “about” before an amount, it refers ±10% of the said amount. Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context requires otherwise, throughout the specification which follow, the word “comprise” and variations thereof, such as, “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

It should also be appreciated that the present disclosure can be implemented in numerous ways, including as a system, a method or a device. In this specification, these implementations, or any other form that the invention may take, may be referred to as processes. In general, the order of the steps of the disclosed processes may be altered within the scope of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C. and a second embodiment comprises elements B and D, then the inventive subject matter is also considered to include other remaining combinations of A, B, C, or D, even if not explicitly disclosed.

The terms ‘mealybug wax’, ‘mealy wax’, ‘mealybug protective coating’, ‘mealybug protective wax coating’, ‘cuticular wax’ and ‘mealy covering’ may be used interchangeably. As used herein, the terms “composition”, “blend”, or “mixture” are all intended to be used interchangeably.

The terms “weight percent”, “volume by volume (v/v) %” “vol-%”, “percent by weight”, “% by weight”, “weight by volume % (w/v)” and variations thereof, as used herein, refer to the concentration of a substance as the weight or volume of that substance divided by the total weight of the composition and multiplied by 100. It is understood that, as used here, “percent”, “%”, and the like are intended to be synonymous with “weight percent”, “vol-%”, etc.

Present disclosure provides an effective method of managing the plant sucking mealybugs which are difficult to manage with conventional methods. The composition of the present disclosure solubilizes the mealy covering around mealybugs, which acts as a barrier for conventional insecticidal penetration, thereby exposing the bug to environmental stresses, predators or insecticidal penetration.

The inventors of the present disclosure studied the mealybug wax and then conducted laboratory studies and field trials to arrive at the optimized composition for its dissolution.

In an embodiment, the present disclosure provides a composition for dissolving the mealybug protective coating comprising a simple polyol and an aminobenzoate ester.

In an embodiment, the present disclosure provides a composition for dissolving mealybug wax comprising active components propane-1, 2, 3-triol and ethyl-4-aminobenzoate.

In an embodiment, the propane-1,2,3-triol may be present in a concentration range of about 1% to about 10% of the composition.

In an embodiment, ethyl-4-aminobenzoate may be present in a concentration range of about 1% to about 10% of the composition.

In an embodiment, the composition further comprises a solvent. The solvent may be any suitable solvent, capable of dissolving the active components, including organic solvents selected from the group comprising of ethyl alcohol, acetone, methanol, ethyl methyl ketone, propan-1-ol (n-propanol), butan-1-ol (n-butanol), 3-methyl-butan-1-ol (isoamyl alcohol), 2-methylpropan-1-ol (isobutyl alcohol), trichloromethane (chloroform), ethoxyethane (ethyl ether) and combinations thereof. In an embodiment, the solvent may be present in a concentration ranging from about 80% to about 98% of the composition.

In an embodiment, the present disclosure provides a composition for dissolving mealybug wax comprising a simple polyol, an aminobenzoate ester and a solvent.

In an embodiment, the composition comprises propane-1, 2, 3-triol, ethyl-4-aminobenzoate and ethyl alcohol.

In an embodiment, the propane-1,2,3-triol may be present in a concentration range of about 1% to about 10% of the composition. In an embodiment, ethyl-4-aminobenzoate may be present in a concentration range of about 1% to about 10% of the composition. In an embodiment, ethyl alcohol may be present in a concentration ranging from about 80% to about 98% of the composition.

In a preferred embodiment, the composition comprises propane-1, 2, 3-triol in a concentration range of about 1% to about 10%, ethyl-4-aminobenzoate in a concentration range of about 1% to about 10% and ethyl alcohol in a concentration range of about 80% to about 98% of the composition.

In another embodiment, the composition comprises propane-1, 2, 3-triol, ethyl-4-aminobenzoate and ethyl alcohol in a ratio range including about 1:1:50 to about 10:10:100, preferably about 1:1:80 to about 10:10:100.

In an embodiment, the composition dissolves or solubilizes the external protective wax coating of the mealybugs. The composition targets the mealy coating of mealybugs thereby, making it beneficial for Integrated Pest Management (IPM) and mealybugs control and eradication programs.

In an embodiment, the composition is effective against multiple species of mealybugs. In an exemplary embodiment, the composition may used against a variety of species of mealybugs, including but not limited to, mango mealybug, cotton mealybug, betelvine mealybug, annona mealybug, pumpkin mealybug, sapota mealybug, citrus mealybug, fiber crops mealybug, cassava mealybug, vine mealybug, grape mealybug, hibiscus mealybug, mulberry mealybug, guava mealybug, ground mealybug, cypress bark mealybug, or sugarcane mealybug. In an exemplary embodiment, the composition may used against variety of species of mealybugs, including but not limited to, Planococcus citri, Rastrococcus iceryoides, Drosicha mangiferae, Ferrisia virgata, Maconellicoccus hirsutus, Dysmicoccus neobrevipes, Saccharicoccus sacchari, Phenacoccus manihoti, Phenacoccus solenopsis, Planococcus ficus, Phenacoccus solani, Rhizoecus spp., or Pseudococcus maritimus.

In an embodiment, the present disclosure provides a formulation for solubilizing mealybug wax comprising a simple polyol, an aminobenzoate ester and an agriculturally acceptable excipient. A formulation for solubilizing mealybug wax, comprising propane-1, 2, 3-triol, ethyl-4-aminobenzoate, a solvent and an agriculturally acceptable excipient.

The solvent may be any suitable solvent, capable of dissolving the active components, including organic solvents selected from the group comprising of ethyl alcohol (ethanol), acetone, methanol, ethyl methyl ketone, propan-1-ol (n-propanol), butan-1-ol (n-butanol), 3-methyl-butan-1-ol (isoamyl alcohol). 2-methylpropan-1-ol (isobutyl alcohol), trichloromethane (chloroform), ethoxyethane (ethyl ether) and combinations thereof.

The agriculturally acceptable excipient may be those well known to a person of skill in the art, including but not limited to, carriers, diluents, emulsifiers, gelling agents, thickening agents, suspension agents, surfactants, preservatives, stabilizers, a dispersing agent, tackifiers, absorption or adsorption enhancing agents, fragrance, adjuvants or mixtures thereof.

The composition and formulation(s) as recited above comprise the active components and the number/amount of excipients may be varied depending upon the formulation and quantity of the active components.

In an embodiment, the present disclosure provides the formulation comprising propane-1,2,3-triol, ethyl 4-aminobenzoate, ethanol, an emulsifier, optionally a gelling agent, and optionally a stabilizer.

In an embodiment, the carrier, diluent and emulsifier may be the same, including but not limited to solvents—acetone, triethanolamine, ethanol, methanol, methyl ethyl ketone, water, double distilled water or combinations thereof. The carrier, diluents or emulsifier may together be present in the range of about 1% to about 95% or more volume by volume percentage of the formulation. The amount of diluents may be dependent upon the plant and the severity of mealybug infestation.

In an embodiment, the gelling agent may be selected from, but is not limited to, polyacrylic acid, polyacrylamide, partially hydrolyzed polyacrylamide, or mixtures thereof. In an embodiment, the gelling agent may be selected from one or more of carbomer, carbopol, polyacrylic acid, cellulose derivatives, ethyl cellulose, hydroxypropyl methyl cellulose, ethyl hydroxyethyl cellulose, carboxymethyl cellulose, hydroxypropyl cellulose, natural rubber, gum arabic, xanthan gum, guar gum, alginates, polyvinyl pyrrolidine derivatives, polyoxyethylene polyoxypropylene copolymers, chitosan, polyvinyl alcohol, pectin, and magnesium aluminum silicate. The concentration of the gelling agent maybe in the range of about 10% to about 60% volume by volume percentage of the formulation.

In an embodiment, the non-limiting examples of stabilizer may be, muriatic acid, propylene glycol, polyethylene glycol, glycerin, ethyl octanoate, ethyl deaconate, ethyl oleate, triethanolamine, monoethanolamide, hydrochloric acid or mixtures thereof. The concentration of the stabilizer may be in the range of about 0.5% to about 15% volume by volume percentage of the formulation.

In an embodiment, the agriculturally acceptable excipient may be present in amounts suitable for their intended purpose.

In an embodiment, the formulation may be formulated into any suitable formulation by selecting suitable agriculturally acceptable excipients. In an embodiment, the formulation may be formulated in the form of a solid, liquid, semi-solid, aerosol or gas. In an embodiment, the formulation may be formulated in the form of blend, liquid, solution, concentrated emulsions, fumigants, wettable powders, powders, granules, water dispersible granules, suspension, tablets, spray, gel, paste, stick, nano formulation, suspoemulsions, or micro-encapsulations.

In an embodiment, the formulation is a liquid formulation comprising the active components in about 1-10% (v/v), and emulsifier or diluent to make the concentrations of 0.1 to 10 ppm.

In an embodiment, there is provided a process for preparing a formulation, a liquid formulation, by dissolving defined amounts of active components in suitable solvent (50-80%) which acts as a diluent and an emulsifier.

In an embodiment, the formulation is a gel formulation comprising the active components in about 0.5-15 ppm (v/v), ethanol in about 50-98% (v/v), carbomer in about 0.5% to about 5% (v/v) as a gelling agent and triethanolamine in about 0.5% to about 5% (w/v) as a stabilizer to stabilize the gel formulation. Gel formulation may be stable for 2-3 years at room temperature and stability may be further maintained by refrigeration.

In an embodiment, gel formulation may be prepared by a process comprising providing a blend of active components by mixing propane-1,2,3-triol, ethyl-4-aminobenzoate and ethanol; providing a gel base by mixing ethanol, carbomer and triethanolamine homogenously; and adding to the gel base, the blend of active components and mixing to provide a gel formulation.

In an embodiment, the formulation is a nano-formulation comprising the active components and a nano carrier. In an embodiment, the nano carriers may be those well-known in the art including titanium dioxide, and nanosilica.

In an embodiment, the nano-formulation is in the form of, but not limited to, nanospheres, nanogels or nanocapsules. In nanospheres, the active components are distributed into a polymeric matrix.

In an embodiment, the formulations of the present disclosure are stable and are persistent with respect to activity of the active components for at least up to 1 year of storage at ambient conditions. Further, storage at lower temperatures 0-4° C. may enhance storage time.

In another embodiment, the present disclosure provides a method of dissolving mealybug wax coating on mealybugs, said method comprising the step of applying on the mealybug a composition comprising propane-1, 2, 3-triol and ethyl-4-aminobenzoate. In an embodiment, the present disclosure provides a method of dissolving mealybug wax coating on mealybugs, said method comprising the step of applying on the mealybug wax a composition comprising propane-1, 2, 3-triol, ethyl-4-aminobenzoate and ethyl alcohol.

In an embodiment, the propane-1,2,3-triol may be present in a concentration range of about 1% to about 10% of the composition. In an embodiment, ethyl-4-aminobenzoate may be present in a concentration range of about 1% to about 10% of the composition.

In another embodiment, the present disclosure provides a method of controlling mealybug infestation, said method comprising the step of applying on mealybug infestation a composition comprising propane-1, 2, 3-triol and ethyl-4-aminobenzoate. In an embodiment, the present disclosure provides a method of controlling mealybug infestation, said method comprising the step of applying on mealybug infestation a composition comprising propane-1, 2, 3-triol, ethyl-4-aminobenzoate and ethyl alcohol.

In another embodiment, the present disclosure provides a method of controlling mealybug infestation, said method comprising the step of applying on mealybug infestation a formulation comprising propane-1, 2, 3-triol and ethyl-4-aminobenzoate. In an embodiment, the present disclosure provides a method of controlling mealybug infestation, said method comprising the step of applying on mealybug infestation a formulation comprising propane-1, 2, 3-triol, ethyl-4-aminobenzoate and ethyl alcohol.

In an embodiment, the propane-1,2,3-triol may be present in a concentration range of about 1% to about 10% of the composition. In an embodiment, ethyl-4-aminobenzoate may be present in a concentration range of about 1% to about 10% of the composition.

In an embodiment, the amount of the formulation or composition applied may depend on the degree of infestation, environmental conditions, soil composition, and/or the composition/formulation. In a preferred embodiment, 5-10% of the formulation may be applied.

In an embodiment, the formulation or composition may be sprayed onto the bugs, but any other method of controlling well known to a person of skill in the art may be employed.

In an embodiment, as per the method recited the composition dissolves the mealybug protective coating to give exposed or naked mealybugs that are sensitive. These sensitive, naked mealybugs either die naturally by desiccation or upon exposure to external stresses including wind, predators, insecticides, or pesticides. Thus, control of mealybug infestation maybe achieved.

The present disclosure provides a composition that can help overcome the need for repeated spraying of and chemical resistance to insecticides.

In an embodiment, the composition reduces the production costs of a crop and insecticidal load on the crops.

In an embodiment, naked mealybug bodies increase its exposure to spray interventions, thus the present method may be employed in IPM, control and eradication programs of mealybugs.

In an embodiment, the method of the present disclosure is effective in decreasing mealybug infestation up to at least 70%, at least 80%, at least 90%, at least 95% or more.

In an embodiment, the plants may be natural plants or genetically modified species. In an embodiment, the method may be employed along with other agricultural pest control and management techniques.

In an embodiment, the method may be repeated at regular intervals in the growing season to control any further infestation.

The compositions, formulations, and method for controlling mealybug in accordance of the present disclosure can help reduce agricultural and horticultural economic losses caused by mealy bugs.

While the foregoing describes various embodiments of the disclosure, other and further embodiments of the disclosure may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### EXAMPLES

The disclosure will now be illustrated with working examples, which is intended to illustrate the working of disclosure and not intended to take restrictively to imply any limitations on the scope of the present disclosure.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, and materials are described herein. It is to be understood that this disclosure is not limited to particular methods, and experimental conditions described, as such methods and conditions may vary.

### Example 1: Extraction of Mealybug Wax

Culturing of mealybugs: Multiple species of mealybugs were cultured in the laboratory on pumpkin (Cucurbita moschata L.) as a laboratory host as per the protocols described for detailed evaluation studies (Kamala Jayanthi, P. D. and B. R. Jayanthi Mala. 2019. Quick estimation of egg number in compact ovisacs of pink hibiscus mealybug, Maconellicoccus hirsutus (Green). Pest Management in Horticultural Ecosystems 25(2): 165-167).

Extraction of mealybug wax: External body cuticular wax of the mealybugs was extracted by following the method of Arunkumar, N., Banu, J. G., Gopalakrishnan, N. et al. The biochemical correlation between the epicuticular wax of upland cotton (Gossypium hirsutuni L.) and the wax of different mealybug species. Phytoparasitica 46, 145-152 (2018). https://doi.org/10.1007/s12600-018-0656-8 and Salunkhe, R. B., Patil, C. D., Salunke, B. K. et al. Effect of wax degrading bacteria on life cycle of the pink hibiscus mealybug, Maconellicoccus hirsutus (Green) (Hemiptera: Pseudococcidae). BioControl 58, 535-542 (2013). https://doi.org/10.1007/s10526-013-9513-3. The glassware used for wax extraction from mealybugs were rinsed with 95% alcohol and sterilized in hot air oven for 12 hrs at 180° C. Mealybugs (40 mg) were collected in a test tube and rinsed with double distilled water for 5 min to remove honey dew and other impurities. Subsequently mealybugs were rinsed with chloroform (1.5 ml) for 6-7 seconds. The quantity of wax extracted was quantified at different time intervals. As a result of these observations, it was noted that a rinse with 1.5 ml of chloroform for 40 mg of mealybugs for 6-7 seconds yielded higher wax (6.37 mg/g). Thus, said process was chosen as usual procedure for wax extraction. The chloroform was evaporated to dryness in a water bath at 70° C. 40 mg mealybugs could yield 0.5 g of wax. The mealybug wax thus obtained was used for characterizing the mealybug wax using GC-MS and for assessing the wax dissolving ability of different compositions.

### Example 2: Preparation of Liquid Formulation

The liquid formulation was prepared by dissolving propane-1,2,3-triol (1%)+Ethyl 4-aminobenzoate (1%) i.e., 10 g and 10 g respectively in solvent ethanol (100 ml), which also acts as a diluent and an emulsifier. This formulation was found to be stable at room temperature (28° C.) during the storage of one year and the formulation stored in cold that is at temperature of 0-4°, the stability was found to be over a year that is 18 months.

### Example 3: Preparation of Gel Formulation

The gel formulation was prepared by providing the gel base by mixing ethanol (60%-99% ethanol v/v), carbomer (5% w/v) and triethanolamine (5% w/v) vigorously for 2-3 min; providing the blend of active constituents by dissolving propane-1,2,3-triol (1%)+Ethyl 4-aminobenzoate (1%) i.e., 10 g and 10 g respectively in solvent 100 ml of ethanol; and adding this blend of active constituents to the gel base and mixed for 2-3 min. furthermore. This formulation was found to be stable for 2-3 years at room temperature and stability was further improved by storage under refrigeration.

### Example 4: Effect of Composition on Solubilizing Mealybug Wax

Different compositions as per Table No. 1 were prepared for dissolving mealybug wax. The compositions were placed in air-tight bottles and stored at −20° C. until further use. These compositions were later evaluated for their solubilizing ability of mealybug wax in the laboratory vis-à-vis associated mortality at 24 h, 48 h, 72 h and a week after spray.

Three compositions namely C1, C2, and C3, were made using the constituents as listed in Table No. 1.

TABLE NO. 1
Compositions for testing mortality of mealybugs

| Compositions | Details |
|---|---|
| Control | Distilled water |
| C1 | 10X concentration of 1% propane-1,2,3-triol + 1% of |
| | Ethyl 4-aminobenzoate i.e., 10 g and 10 g respectively |
| | were dissolved in 100 ml of ethanol as a stock solution, |
| | of which 10 ml was added in 99 ml of distilled water for |
| | making working standard solution and spraying. |
| C2 | 10X concentration of only 1% propane-1,2,3-triol i.e., |
| | 10 g of propane-1,2,3-triol was prepared in 100 ml of |
| | ethanol, and 10 ml from it was used to prepare 100 ml |
| | working standard solution for spraying. |
| C3 | 10X concentration of only 1% Ethyl 4-aminobenzoate |
| | i.e., 10 g of Ethyl 4-aminobenzoate was prepared in 100 |
| | ml of ethanol, and 10 ml from it was used to prepare |
| | 100 ml working standard solution for spraying. |

In-vitro solubility of different composition by adding the wax (200 mg) as obtained in Example 1 to solutions of compositions C1-C3 (1 ml) was tested. It was observed that the wax completely dissolved in Composition C1, whereas it did not dissolve completely in Compositions C2 and C3.

To determine effect of the compositions on the mortality of the mealybugs, the working standard solutions of Table No. 1 and the control (distilled water) with and without stickers were sprayed on to the pink mealybugs (Maconellicoccus hirsutus) and the mortality of mealybugs due to desiccation that succeeded the mealybug wax dissolution was recorded at 24 h, and 48 h after the spray. The working standard solutions of Table No. 1 were directly used to spray on mealy bugs. All blends were evaluated with and without sticker (S) for their efficacy over time periods of 24 h and 48 h. Distilled water was used as control. Sticker was a neutral detergent Tapol.

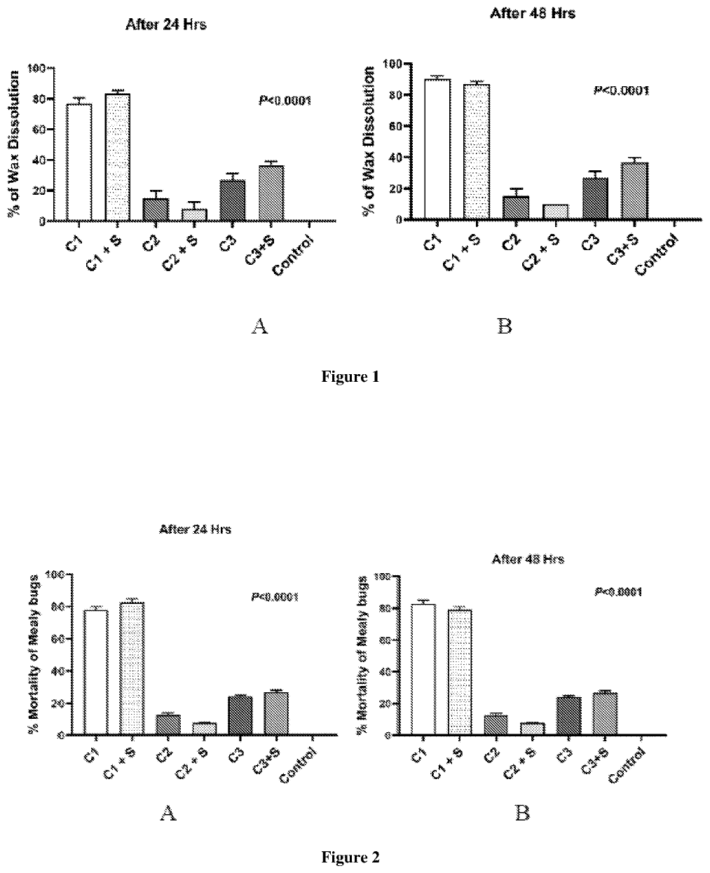

The percentage wax dissolution by application of Compositions C1 to C3 with and without sticker, has been provided in FIG. 1. While, the percentage mortality of mealybugs by application of Compositions C1 to C3 with and without sticker, has been provided in FIG. 2. Maximum mortality was observed with the composition 1 comprising Composition C1 as per the present invention comprising the blend of 1% propane-1,2,3-triol+1% of Ethyl 4-aminobenzoate as against the individual components 1% propane-1,2,3-triol and 1% of Ethyl 4-aminobenzoate comprised in the Compositions C2 and C3 respectively, both of which showed negligible mortality of mealybugs. This proves the surprising effect of the present composition, which is a synergistic composition of propane-1, 2, 3-triol and ethyl 4-aminobenzoate.

### Example 5: Laboratory Trial

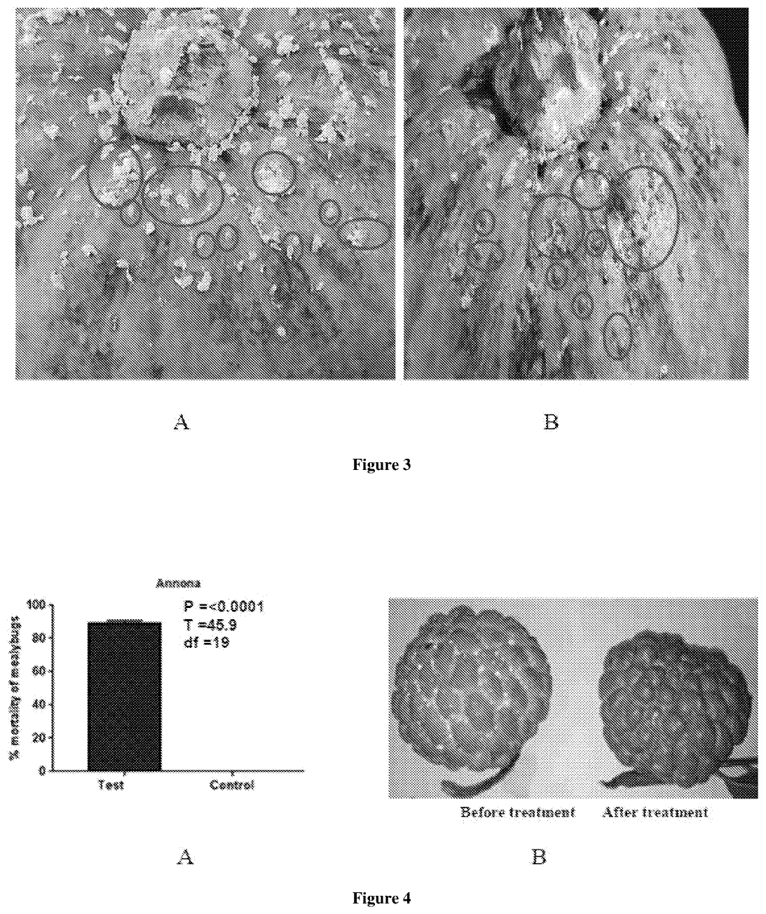

Topical application of the composition C1 (as per Table No. 1 of Example 4) was carried out on mature mealybugs, Planococcus citrii, under laboratory conditions. Mature mealybugs reared on pumpkins are used for the study. The composition C1 was sprayed on to the mealybugs and the mortality of mealybugs due to desiccation that succeeded the mealybug wax dissolution was recorded at 24 h after the spray. Mealybug infested pumpkins without any spray served as control. It was found that the mealybug wax dissolved instantaneously with selected blend whereas in the control no dissolution of wax was noticed (refer FIG. 3).

### Example 6: Field Trials

The Composition C1 (as per Table No. 1 of Example 4) was sprayed onto mature mealybug infested crops-Annona, Mango and Betel vine in the experimental orchards of the Indian Institute of Horticultural Research, Bangalore (13.1348° N, 77.4960° E) (ICAR-IIHR) and were evaluated for its efficacy in a randomized block design. Mealybug infested plants without any spray served as control.

Data from lab and field trials were subjected to ANOVA or t-test. All statistical calculations were performed using GraphPad Prism software for Mac (ver. 6).

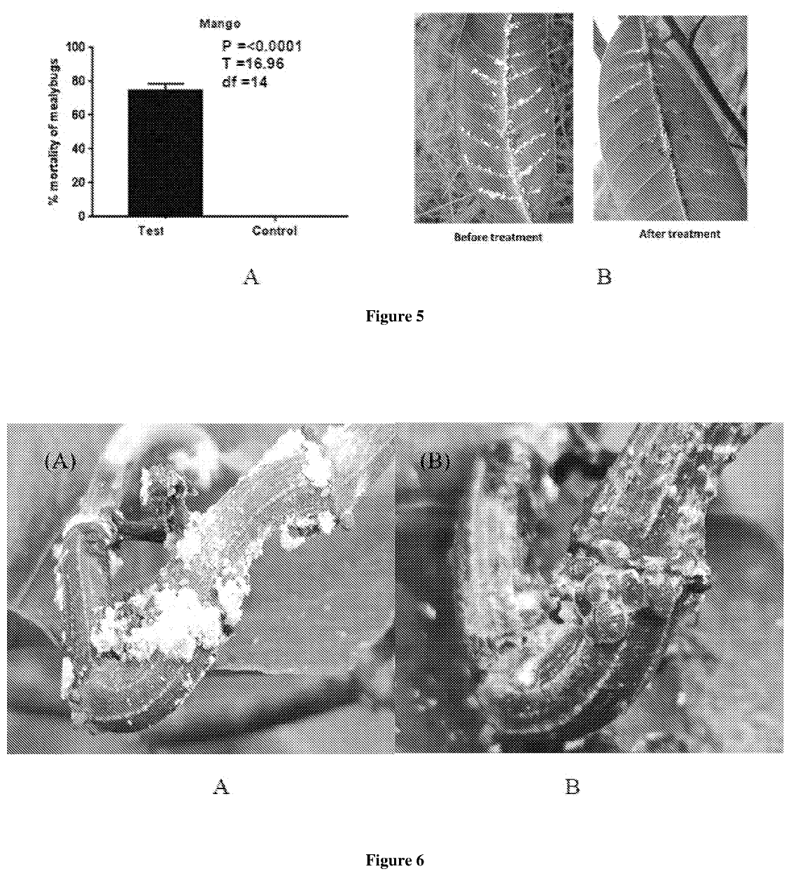

Field evaluation studies on Annona mealybug, and Mango mealybug showed that the Composition C1 dissolved the wax of mealybugs significantly leading to mortality as high as around 90% and 80% respectively after treatment in comparison to control which showed no mortality at all (FIGS. 4A and 5A). Further the effect on solubilizing of the mealybug wax is quite evident in FIGS. 4B and 5B.

Referring to FIG. 6, wherein Figure A is the photograph of close up of betel vine twig showing infestation with mealybugs before treatment, and Figure B shows the same mealybug infested twig with brownish red naked bodies of mealybugs exposed due to solubilizing of the wax covering after the treatment with Composition C1 of the present invention. This result clearly corroborates the ability of the composition of the present invention in dissolving the wax coating on the mealybug, which then lead to mortality of mealybugs due to desiccation.

From the above data, it is evident that the composition of the present disclosure is synergistic and is capable of effectively dissolving the mealy protective coating of mealybug that leaves it exposed or naked. These naked bugs then dry out naturally or due to environmental effects leading to surprisingly significant, as high as above 90%, decline in mealybug infestation.

From the foregoing, it will be appreciated that, although specific embodiments of the invention have been described herein merely for purposes of illustration, various modifications may be made without deviating from the spirit and scope of the invention and should not be construed so as to limit the scope of the invention or the appended claims in any way.

### Advantages of the Present Invention

The present disclosure provides a composition that can solubilize the mealybug protective wax coating.

The present disclosure overcomes the need for repeated spraying of and chemical resistance to insecticides.

The present disclosure provides a composition that is stable and has persistent activity against a variety of mealybug species.

The present disclosure provides a composition that has potential for use in integrated pest management (IPM), control and eradication programs of mealybugs.

1. A composition for solubilizing mealybug wax, wherein the composition comprises propane-1, 2, 3-triol and ethyl-4-aminobenzoate.

2. The composition as claimed in claim 1, wherein propane-1, 2, 3-triol is present in a concentration range of 1% to 10% of the composition.

3. The composition as claimed in claim 1, wherein ethyl-4-aminobenzoate is present in a concentration range of 1% to 10% of the composition.

4. The composition as claimed in claim 1, wherein the composition further comprises a solvent.

5. The composition as claimed in claim 4, wherein the solvent is selected from the group comprising of ethyl alcohol, acetone, methanol, ethyl methyl ketone, propan-1-ol, butan-1-ol, 3-methyl-butan-1-ol, 2-methylpropan-1-ol, trichloromethane, ethoxyethane and combinations thereof.

6. The composition as claimed in claim 1, wherein the composition comprises propane-1, 2, 3-triol, ethyl-4-aminobenzoate and ethyl alcohol.

7. The composition as claimed in claim 6, wherein ethyl alcohol is present in a concentration ranging from 80% to 98%.

8. The composition as claimed in claim 6, wherein the composition comprises propane-1, 2, 3-triol, ethyl-4-aminobenzoate and ethyl alcohol in a ratio range of 1:1:80 to 10:10:100.

9. A formulation for solubilizing mealybug wax, wherein the formulation comprises propane-1, 2, 3-triol, ethyl-4-aminobenzoate, a solvent and an agriculturally acceptable excipient.

10. The formulation as claimed in claim 9, wherein the solvent is selected from the group comprising of ethyl alcohol, acetone, methanol, ethyl methyl ketone, propan-1-ol, butan-1-ol, 3-methyl-butan-1-ol, 2-methylpropan-1-ol, trichloromethane, ethoxyethane and combinations thereof.

11. The formulation as claimed in claim 9, wherein the agriculturally acceptable excipient is selected from carriers, diluents, emulsifiers, gelling agents, thickening agents, suspension agents, surfactants, preservatives, stabilizers, a dispersing agent, tackifiers, absorption or adsorption enhancing agents, fragrance, adjuvants or mixtures thereof.

12. The formulation as claimed in claim 11, wherein the carriers, diluents, or emulsifiers are selected from acetone, triethanolamine, ethanol, methanol, methyl ethyl ketone, water, double distilled water or combinations thereof.

13. The formulation as claimed in claim 11, wherein the gelling agent is selected from one or more of carbomer, carbopol, polyacrylic acid, cellulose derivatives, ethyl cellulose, hydroxypropyl methyl cellulose, ethyl hydroxyethyl cellulose, carboxymethyl cellulose, hydroxypropyl cellulose, natural rubber, gum arabic, xanthan gum, guar gum, alginates, polyvinyl pyrrolidine derivatives, polyoxyethylene polyoxypropylene copolymers, chitosan, polyvinyl alcohol, pectin, and magnesium aluminum silicate.

14. The formulation as claimed in claim 11, wherein the stabilizer is selected from muriatic acid, propylene glycol, polyethylene glycol, glycerin, ethyl octanoate, ethyl deaconate, ethyl oleate, triethanolamine, monoethanolamide, hydrochloric acid or mixtures thereof.

15. The formulation as claimed in claim 11, wherein the concentration of the diluent, emulsifier or carrier is in the range of 1% to 95% or more (v/v) of the formulation, the concentration of the gelling agent is in the range of 10% to 60% (v/v) of the formulation; and the concentration of the stabilizer is in the range of 0.5% to 15% (v/v) of the formulation.

16. The formulation as claimed in claim 9, wherein the formulation is formulated in the form of blend, liquid, solution, concentrated emulsions, fumigants, wettable powders, powders, granules, water dispersible granules, suspension, tablets, spray, gel, paste, stick, nano formulation, suspoemulsions, or micro-encapsulations.

17. A method of controlling mealybug infestation, said method comprising applying on mealybug infestation a composition comprising propane-1, 2, 3-triol and ethyl-4-aminobenzoate.
